(19) United States
(12) Patent Application Publication
(10) Pub. No.: US 2002/0013724 A1
(43) Pub. Date: Jan. 31, 2002

(54) Schedule information system

(75) Inventors: Masato Kudo, Tokyo (JP); Hajime Takano, Tokyo (JP)

Correspondence Address: Thomas G. Bilodeau, FOLEY & LARDNER, Washington Harbour, 3000 K Street, N.W., Suite 500, Washington, DC, 20007-5109, US

(73) Assignee: NEC CORPORATION

(21) Appl. No.: 09/916,579

(22) Filed: Jul. 30, 2001

(30) Foreign Application Priority Data
Jul. 31, 2000 (JP) 231598/2000

(51) Int. Cl. G06F 17/60

(52) U.S. Cl. 705/9

(57) ABSTRACT

A means is provided for presenting a user—when he consults his own schedule or when he has issued an instruction—with information services found by searching information services relating to the schedule data of the user, these schedule data having been stored in a schedule management service.

### BACKGROUND OF THE INVENTION

1. Field of the Invention

The present invention relates to a schedule management service that uses an information processing system to manage the schedules of users. It also relates to a schedule information system for providing, on the basis of cooperation between a schedule management service and information providing services, information relevant to the schedules of users. The invention can also be utilized as an information providing service in which the information provision can include advertisements.

2. Description of Related Art

There are schedule management services that utilize a network such as the Internet to manage the schedules of users. Information processing systems within enterprises also have schedule management systems for managing the schedules of personnel.

In such systems, the user can only perform schedule management related operations such as adding, updating or canceling schedule items, and cannot utilize, from within the schedule management service, other information services provided on networks, nor can the user arrange for information obtained by utilizing other information services to be reflected in the schedule management service.

Accordingly, troublesome procedures have had to be undertaken whenever a user has tried to manage, within a schedule management service, useful information which, although distinct from the content to be registered as a scheduled arrangement, was nonetheless related to that content. For example, when a user has arranged to be out of the office and is registering this arrangement with a schedule management service, but wishes to check what time he will have to leave in order to reach the intended destination on time, and to include this information as part of the registered arrangement, it has previously been necessary to temporarily break off access to the schedule management service, access a route-finding service provided on a network, and then incorporate the results obtained there in the arrangement being registered.

Thus a problem that has been encountered is that despite a large variety of information services being provided on networks, it has been impossible to make effective use of their resources or to perform flexible and efficient schedule management. Moreover, it has been necessary for the user himself to gather information relating to specific scheduled items such as meetings, appointments, business trips and journeys that have been registered as part of his schedule; and it has been impossible to provide the user with related information in an easy-to-use form.

### SUMMARY OF THE INVENTION

The present invention overcomes such problems. It is an object of the invention to provide a schedule information system which enables users of the system to easily gather information relating to a schedule; which facilitates increased utilization of information provided by information services; and which can make effective use of the information resources of such services. It is another object of the invention to provide a schedule information system capable of helping a user of a schedule management system to gather information, and of providing users with greater convenience.

The present invention is utilized in a schedule management service for managing the schedules of users. It comprises schedule data storage means in which users' schedule data are stored, and information service means for providing users with information. It also comprises related service search means that searches information service means that relate to schedule data stored in the schedule data storage means. The related service search means includes means which, in response to user instructions to search related services or to consult schedule data, acquires information from information service means that relate to schedule data, and outputs this information to the user.

As a result, this invention can access an information service related to a user's schedule and automatically collect relevant information and present it to the user. It can therefore assist in the collection of relevant data by a user and can provide users with greater convenience.

The invention also comprises information service data storage means in which information summarizing the aforementioned information service means is stored. The aforementioned related service search means can also include means that searches the aforementioned information service data storage means in response to user instructions or control, and can be provided with means for outputting to the user, along with the aforementioned schedule data, information from the information service means that have been searched by the related service search means.

Searching related information services is readily accomplished by utilizing a database in which information such as outlines of information services is stored.

The aforementioned information service data storage means can also include means for storing information relating to the access address and access procedure for the information service means, and for connecting to the information service means on the basis of this access address and procedure information that have been retrieved by the related service search means. By acquiring the information required to access an information service means, access to an information service means that has been found can be automatically started and its information service received.

The invention can also include means for receiving schedule data related information from an information service means to which a connection has been established, and for outputting the received information along with the aforementioned schedule data.

The invention can also include billing information storage means for receiving billing information from a connected information service means and for storing billing information for each user.

The invention can also comprise personal information storage means for storing personal information relating to users, and the aforementioned related service search means can include means for using this personal information along with the schedule data to search the information service data storage means.

The invention can also include user preferences extraction means for extracting information inferred—on the basis of schedule data input by a user or information from information service means provided by a user—to be of interest to the user, and for using the extracted information as part of the aforementioned personal information.

The invention can also include means for acquiring information relating to the aforementioned personal information by connecting to an information service means found by the related service search means on the basis of the personal information stored in the personal information storage means, and for storing this acquired information in the aforementioned user schedule data storage means as part of the schedule data of the user in question.

The aforementioned information service data storage means can also be provided with information service data registration means whereby the user can register information from an information service means.

The invention can also be provided with information service data acquisition means for searching, on the basis of the personal information stored in the personal information storage means, information service means that are in conformity with this personal information; and for storing, in the information service data storage means, information from the searched information service means.

The information service means can comprise means which, when there is information to be registered as schedule data with the schedule data storage means, requests transmission of the schedule data to the schedule data storage means; and data transmit/receive means for receiving this schedule data, retrieving information congruent with the received schedule data, and transmitting the acquired information.

The invention can also comprise display means for presenting the user with information acquired from an information service means; and can be provided with animated character image generation means for generating animated character images for displaying on this display means, and with means for displaying the animated character images along with the aforementioned acquired information.

The invention can also comprise means for selecting a display scenario that is appropriate for the schedule data; and means which, in accordance with the movement pattern obtained by this display scenario selection means, displays the aforementioned animated character images and outputs what the character says.

Animated character images appeal to people and tend to attract the user's attention, thereby giving the presented information greater impact.

The present invention is configured as a system in which client terminals are connected to a server via a network, wherein the aforementioned server contains the aforementioned schedule data storage means, related service search means, information service data storage means, and means for outputting to users information acquired from the information service means.

The information service data storage means can also contain Internet location information as the address information for accessing the information service means.

Apart from the information service means, all means of the invention can be contained in a terminal that is connectable to the information service means via a network.

A terminal can include the aforementioned schedule data storage means, related service search means, information service data storage means, and means for outputting to a user information acquired from an information service means.

The present invention can also be implemented as a storage medium in which software has been stored, this software functioning as a schedule information system when installed in an information processing unit.

### BRIEF DESCRIPTION OF THE DRAWINGS

Specific embodiments of the present invention will now be described, by way of example only, with reference to the accompanying of drawings in which:

FIG. 1 shows an example of the configuration of a schedule information system of the present invention;

FIG. 2 is a block diagram showing the configuration of a first embodiment;

FIG. 3 shows the attributes of schedule data to be registered;

FIG. 4 shows the attributes of information service data stored in the information service data storage means;

FIG. 5 is a flow diagram illustrating the operation of registering schedule data;

FIG. 6 is an example of a display screen when a schedule is being consulted;

FIG. 7 is an example of a detailed schedule display screen;

FIG. 8 is a flow diagram illustrating the operation of retrieving and displaying a list of information services;

FIG. 9 is an example of an information service list display screen;

FIG. 10 is a flow diagram illustrating the operation of retrieving and displaying a list of information services in response to an instruction to refer to a schedule;

FIG. 11 is an example of a schedule consultation screen;

FIG. 12 is a flow diagram illustrating the operation in response to an instruction to call related information services;

FIG. 13 is a flow diagram illustrating the operation in response to an instruction to call a particular information service;

FIG. 14 is a flow diagram illustrating the operation in response to a user instruction to display related information services;

FIG. 15 is a flow diagram illustrating the operation of calling an information service in response to an instruction to display the details of an arrangement;

FIG. 16 is a flow diagram illustrating the operation of calling an information service when a schedule consultation screen has been displayed;

FIG. 17 is a block diagram showing the configuration of a second embodiment;

FIG. 18 is a block diagram showing the configuration of a third embodiment;

FIG. 19 shows the attributes of billing information;

FIG. 20 is a block diagram showing the configuration of a fourth embodiment;

FIG. 21 shows the attributes of the user information;

FIG. 22 shows the attributes of the account information;

FIG. 23 is an example of a user information setting screen;

FIG. 24 is a block diagram showing the configuration of a fifth embodiment;

FIG. 25 is a block diagram showing the configuration of a sixth embodiment;

FIG. 26 is a block diagram showing the configuration of a seventh embodiment;

FIG. 27 is a block diagram showing the configuration of an eighth embodiment;

FIG. 28 is a block diagram showing the configuration of a ninth embodiment; and

FIG. 29 shows the configuration of a tenth embodiment.

### DETAILED DESCRIPTION OF THE PREFERRED EMBODIMENTS

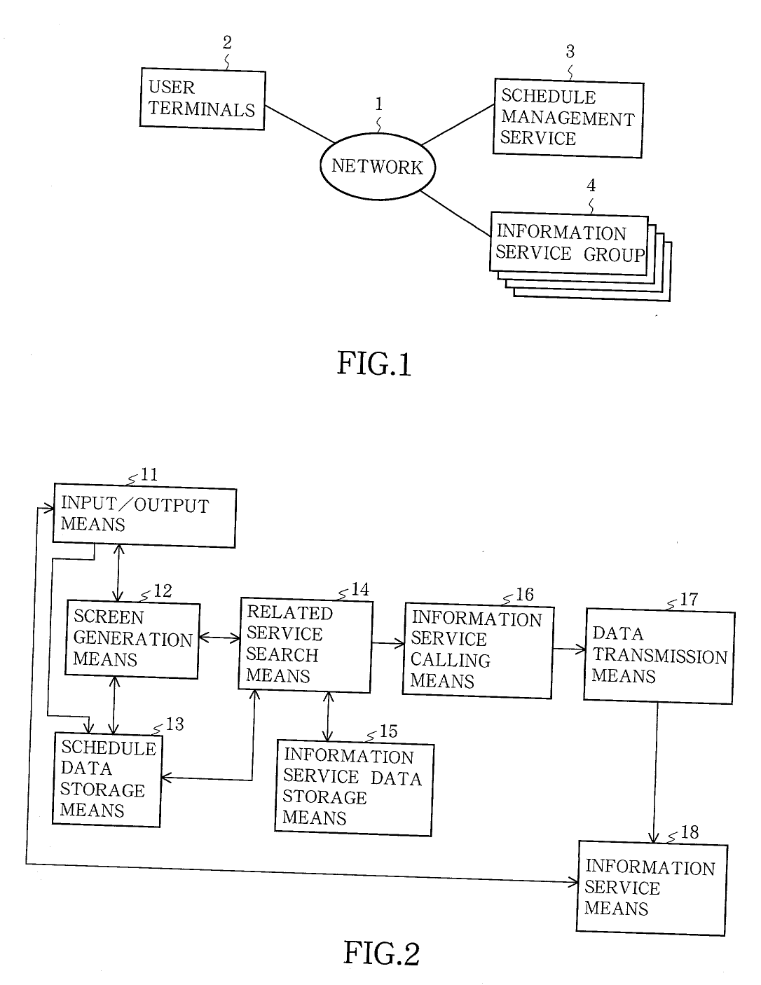

An example of the overall system configuration of embodiments of this invention will be described with reference to FIG. 1. This example shows a schedule information system in which a plurality of user terminals 2 are connected via network 1 to schedule management service 3 and information service group 4. Information service group 4 provides a variety of information services such as news, travel information and weather information, and is made available to users via the network. Network 1 includes a variety of networks such as the Internet and intranets. Schedule management service 3 provides a schedule management service for each user, serving to store users' schedule data (where “user” can signify both an individual user and a group of individual users) and to provide stored schedule data to users who wish to refer to such data. A variety of schedule management software is provided to implement this schedule management service.

The present invention is a schedule information system arranged to operate on the basis of co-operation between this schedule management service 3 and information service group 4.

### First Embodiment

FIG. 2 shows the configuration of a first embodiment of the invention.

This first embodiment comprises input/output means 11, screen generation means 12, schedule data storage means 13, related service search means 14, information service data storage means 15, information service calling means 16, data transmission means 17 and information service means 18.

These means illustrated in FIG. 2 will now be described.

Input/output means 11 serves to present users with screens from the schedule management service and from information services, and enables users to input instructions. In the configuration illustrated in FIG. 1, this input/output means 11 is located at user terminal 2. It accepts input (instructions, etc.) from the user and also operates as a display means for outputting data to the user. If schedule management service 3 and user terminal 2 are implemented on the same physical equipment, then input/output means 11 operates as the input/output device of the physical equipment on which the schedule management service operates.

Screen generation means 12 is provided between input/output means 11 on the one hand, and schedule data storage means 13 and related service search means 14 on the other. Screen generation means 12 serves to generate a variety of screens for presenting to users, including display screens for input and output (e.g., for registering or displaying schedule data), screens used when giving instructions to search related services or when displaying the search results, and screens from information service means that have been called.

Screen generation means 12 performs the following specific operations:

(1) It receives instructions from input/output means 11, acquires—from schedule data storage means 13—schedule data that have been established for a specified date, and generates a display screen for those data.

(2) It receives instructions from input/output means 11, sends instructions to related service search means 14 to search, in information service data storage means 15, for information service means 18 that are related to the specified schedule data, and generates a screen for presenting the user with the information sent back from related service search means 14 regarding related services.

(3) If there has been an instruction, from input/output means 11, to call an information service means 18 that was presented to the user via screen generation in operation (2) above, screen generation means 12 generates a screen for presenting the user with the information that has been sent from information service means 18 that has been called.

(4) A mechanism is maintained within screen generation means 12 for defining processing to be carried out at the same time as the screen data generation process is executed (e.g., calling a related information service such as an advertising service). When screen data are generated, the processing defined by this mechanism is performed.

(5) If registration and storing of user information are separate operations, screen generation means 12 generates a screen for registration and a screen for displaying registered user information.

Schedule data storage means 13 serves to store the schedule data of users. Schedule data registered by users is not the only data that can be stored. Advertising information and recommendations of various kinds provided by information service means 18 can also be registered. As a rule, the schedule data stored in schedule data storage means 13 is managed on a per user basis.

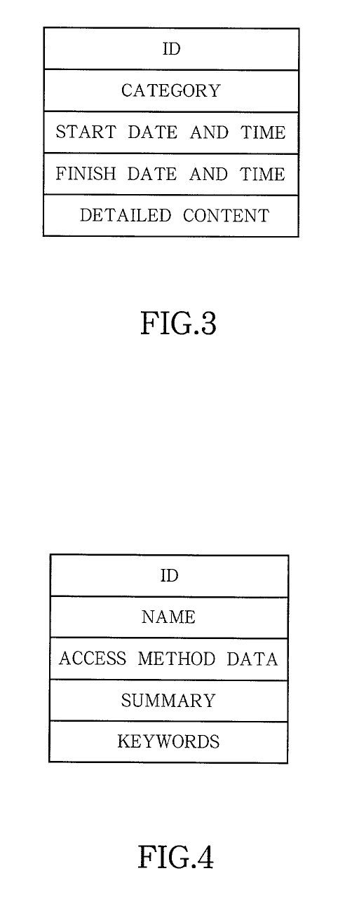

FIG. 3 shows the configuration of the schedule data stored in schedule data storage means 13. The following information is stored in correspondence with each identification number: schedule category information; start date and time; finish date and time; and schedule details. The category information comprises keywords indicative of the content of the stored information, i.e., whether an arrangement, advertisement, recommendation, etc., is involved. Examples of such keywords are “appointment”, “business trip” and “visitor”. The information stored under schedule details includes the arrangement title, where the meeting etc. will take place, a memo, the URL of any reference materials, and information specified by the user, advertisement provider or provider of recommended information.

Related service search means 14 serves to search information service means 18 related to schedule data that has been specified or consulted—specifically, related to schedule category or arrangement title. The instruction to search related services is sent to related service search means 14 when screen generation means 12 generates a screen for presenting services related to specified schedule data. When this instruction is sent, related service search means 14 acquires schedule data from schedule data storage means 13, extracts a search key from it, and searches information service means 18 that is related to the schedule data. A variety of search techniques can be used, including keyword extraction and using a thesaurus to find analogous keywords. Related service search means 14 also searches information service data storage means 15, sends the extracted data to screen generation means 12 which displays it, issues an instruction to information service calling means 16 to connect to information service means 18—e.g., an Internet-based search engine—and search the related information services; and sends the returned data back to screen generation means 12.

Related service search means 14 searches information services relating to schedule data. However, it can have an information selection function whereby it selects, from the data retrieved from the related information services that have been searched, what information should be presented to each user, and presents this information via screen generation means 12, which generates screens for presenting to users, and input/output means 11.

Information service data storage means 15 stores data relating to each information service means 18, such as the name of the information service means, a summary of its content, and the access procedure or method. It also stores keywords indicative of the content of each information service. FIG. 4 shows an example of the information service data that is stored in information service data storage means 15. The name of an information service means 18 is stored under “name”; and the URL or telephone number to be used when calling this information service means is stored under “access method data”, together with any authentication etc. required for accessing the service. Sentences summarizing the information service are stored under “summary”; and keywords indicative of the content or related areas of the information service, and of recommendations, are stored under “keywords”.

Information service calling means 16 connects to and calls information service means 18 via data transmission means 17, on the basis of an instruction from related service search means 14.

This first embodiment of the invention can have the following four system configurations:

(1) Only input/output means 11 is located on user terminal 2 of FIG. 1, while the other constituent elements are provided somewhere within the network, with screen generation means 12, schedule data storage means 13, related service search means 14, information service data storage means 15, information service calling means 16 and data transmission means 17 being located in schedule management service 3, and information service means 18 being located in information service group 4.

(2) Constituent elements apart from information service means 18, related service search means 14 and information service data storage means 15 are located on user terminal 2, with related service search means 14 and information service data storage means 15 being located on the schedule management service side.

(3) All constituent elements apart from information service means 18 are located on user terminal 2, with information service means 18 being connected via the network.

(4) The entire configuration shown in FIG. 2 is located on the user terminal.

The working of this first embodiment will now be described. Namely, it performs the following operations: (1) registering a user's schedule data via the input/output means 11 of the user; (2) enabling a user to consult schedule data; (3) retrieving a list of information services related to the schedule data that a user is consulting, and displaying this list to the user; (4) guiding a user to information service means related to the schedule data that the user is consulting. These operations will now be described one by one.

### (1) Operation When a User Registers Schedule Data

First of all, the user inputs a request to input/output means 11 to create a schedule item. In response to this request, input/output means 11 requests screen generation means 12 to generate a schedule registration screen. Screen generation means 12 generates a schedule registration screen and sends the data to input/output means 11, which displays the screen for registering schedule data. The user then uses input/output means 11 to create, and request registration of, a schedule item, and input/output means 11 sends the generated data to schedule data storage means 13. Schedule data storage means 13 stores the received data as a single schedule data item.

The foregoing operations are the same as schedule registration in a conventional schedule management service.

### (2) Operation When a User Consults Schedule Data

This operation is performed when a user requests input/output means 11 to display a schedule consultation screen after having specified the period that he wishes to look at. Alternatively, it is performed when a user has accessed the schedule management service after specifying a schedule item that he wishes to consult in detail.

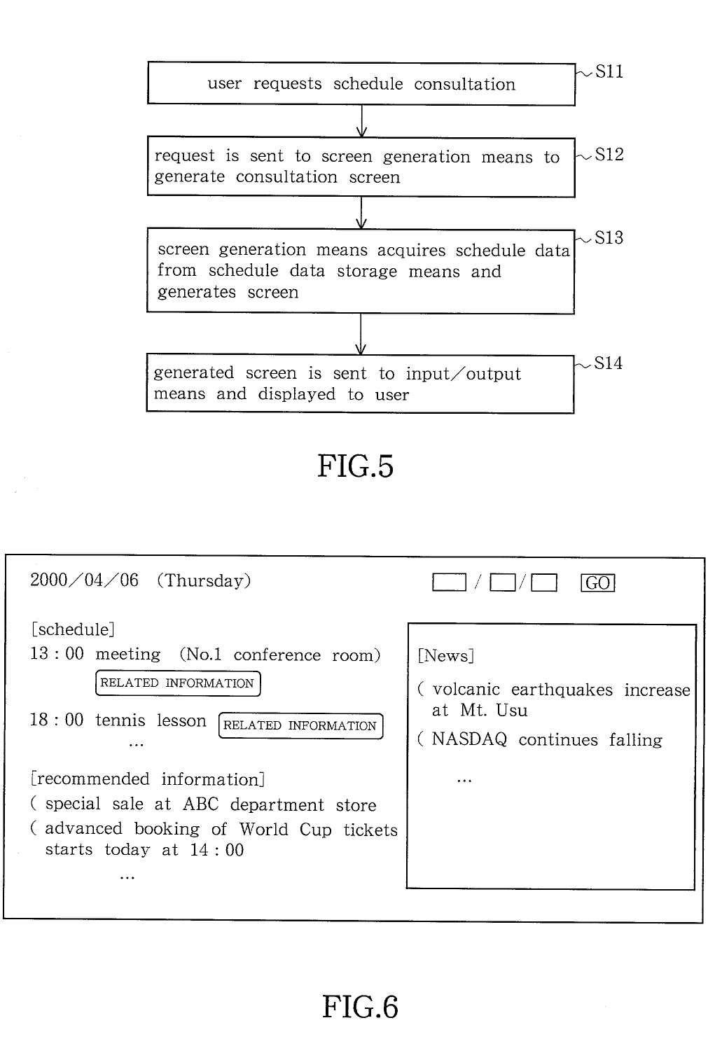

This operation is approximated by the flow diagram of FIG. 5. Namely, when a user makes a request to consult his schedule (S11), input/output means 11 requests screen generation means 12 to generate a screen (S12), whereupon screen generation means 12 acquires schedule data stored in schedule data storage means 13 and generates a schedule consultation screen (S13), which is then sent to input/output means 11 for display to the user (S14).

This will be explained in greater detail. First of all, when a user has requested the display of a schedule consultation screen, input/output means 11 sends the schedule consultation screen generation request to screen generation means 12, along with a value for the period in question if a look-up period has been specified. If a single schedule item has been specified, it sends the schedule consultation screen generation request along with the identification number of the specified schedule item. If the user has already begun accessing the schedule management service, it sends the schedule consultation screen generation request along with a value for the day on which access is made. If a period has been specified, screen generation means 12 acquires, from schedule data storage means 13, schedule data having a start date and time within the specified period, and generates a schedule data consultation screen. If a single schedule item has been specified by the user, it acquires schedule data pertaining to the specified schedule item and generates a schedule consultation screen. If the schedule management service is already being accessed, screen generation means 12 acquires schedule data with a start day and time corresponding to the day on which access was begun, and generates a schedule consultation screen. In each case the schedule consultation screen is displayed to the user via input/output means 11.

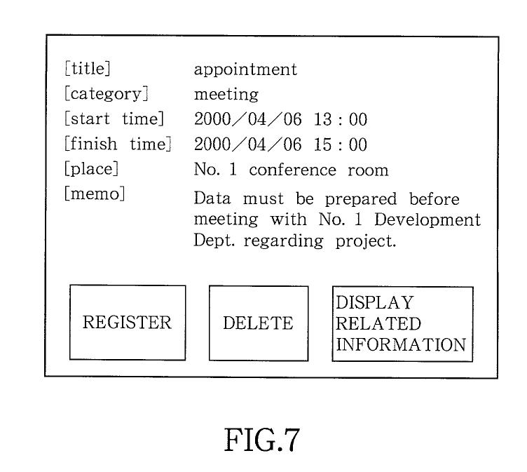

FIG. 6 gives an example of the schedule consultation screen that is displayed. This example shows the schedule consultation screen that is displayed when Apr. 6, 2000 has been specified. In this example, an appointment at 13:00 and a tennis class at 18:00 have been registered as the user schedule events. FIG. 7 gives an example of the screen that is displayed when a schedule item is displayed in detail.

Screen generation means 12 generates this sort of display data, and these are sent to input/output means 11 and displayed on a display device.

### (3) Operation of Retrieving a List of Related Information Services and Displaying This List to a User

This operation can be divided into the following two situations: 1) there is an instruction from a user to display information services related to a certain schedule item; 2) there is an instruction from a user to display a certain schedule item in detail, and information services related to this schedule item are concurrently displayed along with the schedule item details.

Situation 1) occurs when a screen for displaying a certain schedule item in detail has previously been displayed and a button (i.e., an icon) having the function of displaying a list of related information services is provided on this screen. It also occurs when a consultation screen listing schedule items within a certain period has been displayed and a button having the function of displaying a list of related information services is provided at each schedule item. Buttons labeled “related information” are provided on the screen illustrated in FIG. 6. Situation 2) occurs when the option to display a list of related information services is included in a screen displaying a certain schedule item in detail. A button labeled “display related information” is provided in the detailed schedule item display illustrated in FIG. 7.

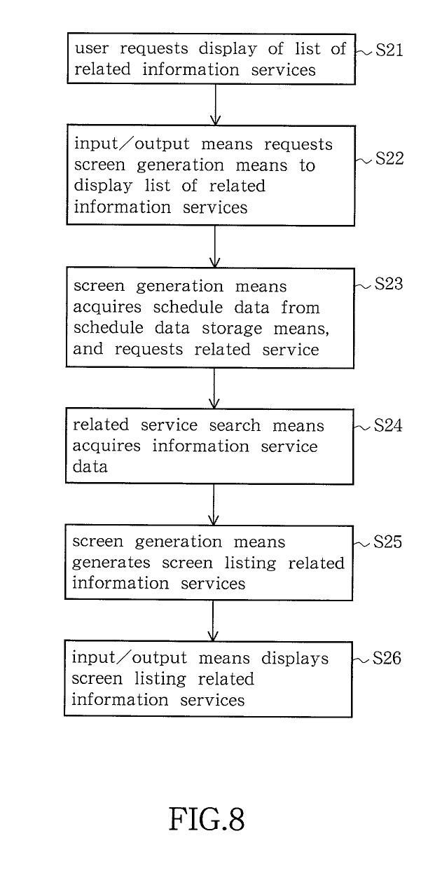

First of all, the operation of retrieving and displaying a list of related information services will be described with reference to FIG. 8 (Situation 1).

A user inputs, to input/output means 11, a request to display a list of information services related to a certain schedule item (S21). This request input is performed, for example, by clicking on a button labeled “related information” in FIG. 6. As a result of this user operation, input/output means 11 transfers, to screen generation means 12, the request for a list of related information services, along with the identification number of the specified schedule item (S22). Screen generation means 12 uses the transferred schedule item identification number to acquire, from schedule data storage means 13, schedule data having that identification number, and transfers this schedule data, along with a request to search related information services, to related service search means 14 (S23). Related service search means 14 generates search keywords from the transferred schedule data, acquires from information service data storage means 15 all the data relating to information service means 18 that have keywords that match these search keywords, and transfers the acquired data to screen generation means 12 (S24). Screen generation means 12 uses the transferred information service related data to generate a screen listing related information services, and transfers the screen data to input/output means 11 (S25). At this point, if a URL is included as information service related data, the data associated with this URL can be utilized to create a link in the screen for calling that information service directly. Input/output means 11 then displays, for the user, the screen listing the related information services that have been found (S26).

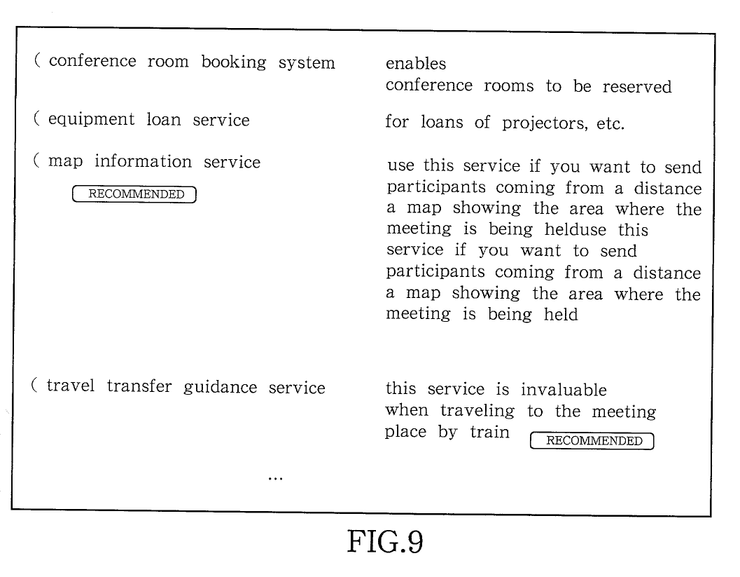

FIG. 9 shows an example of this screen displaying a list of related services.

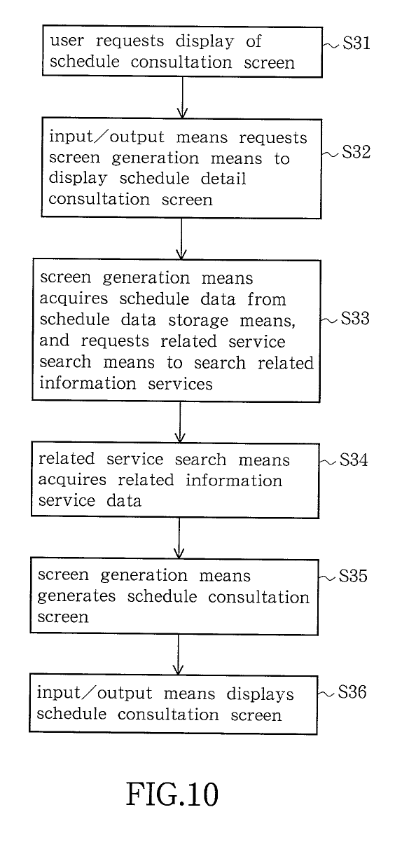

Next, the operation of retrieving and displaying a list of information services when a user has input an instruction to consult detailed schedule data will be described with reference to FIG. 10 (Situation 2).

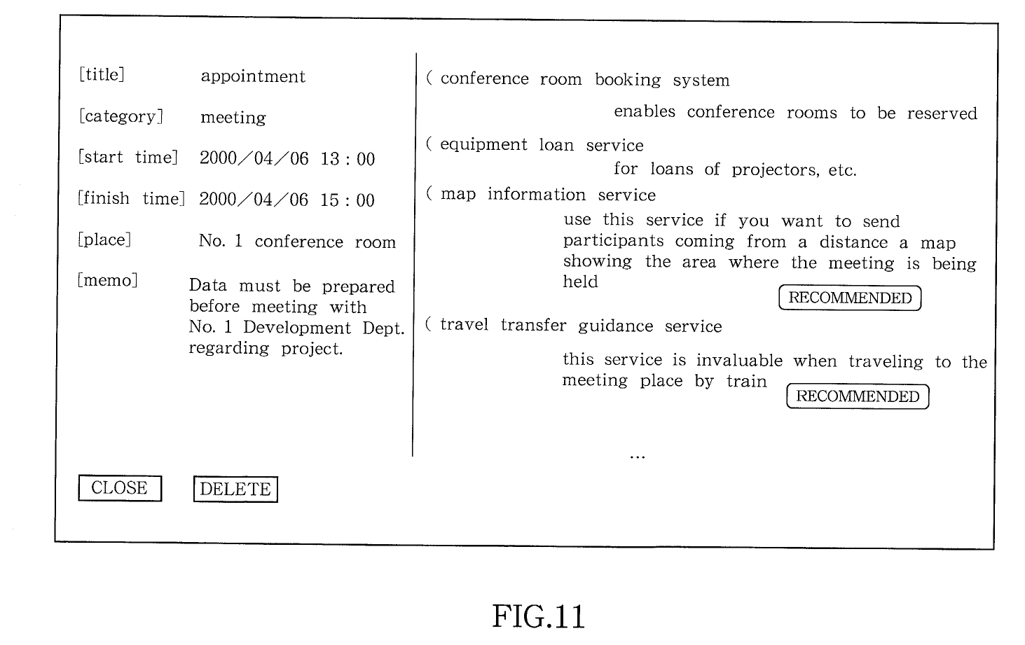

First of all, the user specifies a schedule item that he wishes to consult in detail and inputs, to input/output means 11, a request to display a schedule consultation screen (S31). As a result, input/output means 11 sends, to screen generation means 12, a request to display a schedule detail consultation screen, along with the identification number of the specified schedule item (S32). Screen generation means 12 uses the transferred identification number to acquire schedule data from schedule data storage means 13, and sends this data to related service search means 14 along with a request to search related information services (S33). As in the flow diagram of FIG. 8, related service search means 14 generates search keywords from the transferred schedule data and acquires from information service data storage means 15 data relating to information service means 18 that have keywords that match these search keywords (S34). It then transfers this acquired data to screen generation means 12. Screen generation means 12 uses the previously acquired schedule data, plus the information service means 18 related data that has been transferred from related service search means 14, to generate a schedule consultation screen (S35). At this point, if the data relating to information service means 18 includes URLs as access method related data, the data associated with these URLs can be utilized to create a link in the screen for calling those information services directly. The screen data are then sent to input/output means 11 which presents the screen to the user (S36). FIG. 11 shows an example of this schedule consultation screen. In FIG. 11, detailed information relating to the schedule is displayed on the left-hand side of the screen, and information services related to the displayed schedule item are indicated on the right-hand side. In this example, the URL of an information service is linked to the displayed service name, so that the user can connect to an information service means 18 by clicking on the service name.

### (4) Operation When Guiding a User to Related Information Services

This operation can be divided into the following five situations:

1) A user gives instructions to call one of the information services appearing in the list displayed in the screen that presents a list of related information services, where a link has been formed for the service in question.

2) A user gives instructions to call one of the information services appearing in the list displayed in the screen that presents a list of related information services, where a call command is embedded after reference is made to the access method for that information service.

3) A user calls a related information service directly after giving instructions to display services related to a certain schedule item.

4) A user calls a related information service directly after giving instructions to display a certain schedule item in detail.

5) A user calls a related information service directly after he has caused a schedule consultation screen to be displayed and has specified a period that he wishes to consult, or after he has started to access the schedule management service and has caused a schedule consultation screen to be displayed.

The operation performed in each of these situations will now be described with reference to drawings.

1) A user gives instructions to call one of the information services appearing in the list displayed in the screen that presents a list of related information services, where a link has been formed for the service in question.

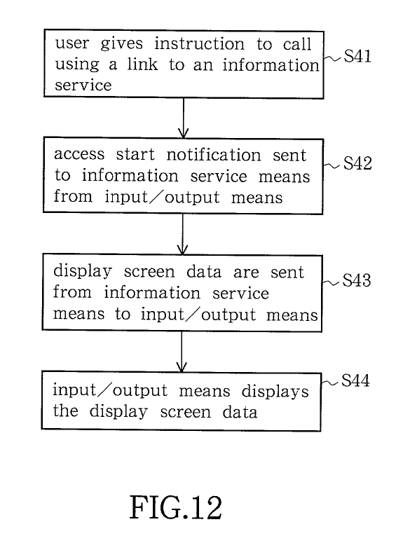

FIG. 12 is a flow diagram serving to describe this operation. First of all, a user gives instructions to call a certain information service means 18 by using a link appearing in the related information service list display screen being presented by input/output means 11 (S41). When a link to information service means 18 has been embedded in the screen shown by way of example in FIG. 9, clicking on this link constitutes an instruction to access the information service means in question. As a result of this call instruction, an access start notification is transferred to the information service means 18 that was indicated from input/output means 11 (S42). As a result of this notification, display screen data are sent from information service means 18 to input/output means 11 (S43), which displays the received data (S44).

2) A user gives instructions to call one of the information services appearing in the list displayed in the screen that presents a list of related information services, where a call command is embedded after reference is made to the access method for that information service.

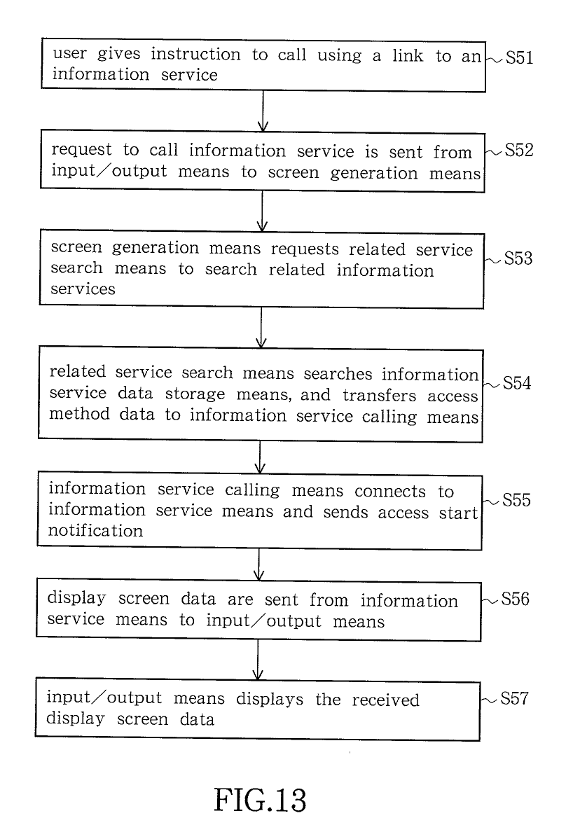

FIG. 13 is a flow diagram showing this operation. First of all, a user gives instructions to call a certain information service by using a link appearing in the related information service list display screen being presented by input/output means 11 (S51). As a result of this call instruction, an information service call request is sent, along with the identification number of the specified information service, from input/output means 11 to screen generation means 12 (S52). Screen generation means 12 sends, to related service search means 14, a related information service search request along with the transferred identification number (S53). Related service search means 14 uses the transferred identification number to acquire, from information service data storage means 15, data relating to an information service that has a matching information service identification number, looks up the “access method data” contained within this acquired data, and transfers this data to information service calling means 16 (S54). Information service calling means 16 uses the received “access method data” to connect to information service means 18 via data transmission means 17, and sends an access start notification to information service means 18 (S55). Display screen data are sent from accessed information service means 18 to input/output means 11 (S56), and input/output means 11 displays the received display screen data (S57).

3) A user calls a related information service directly after giving instructions to display information services related to a certain schedule item.

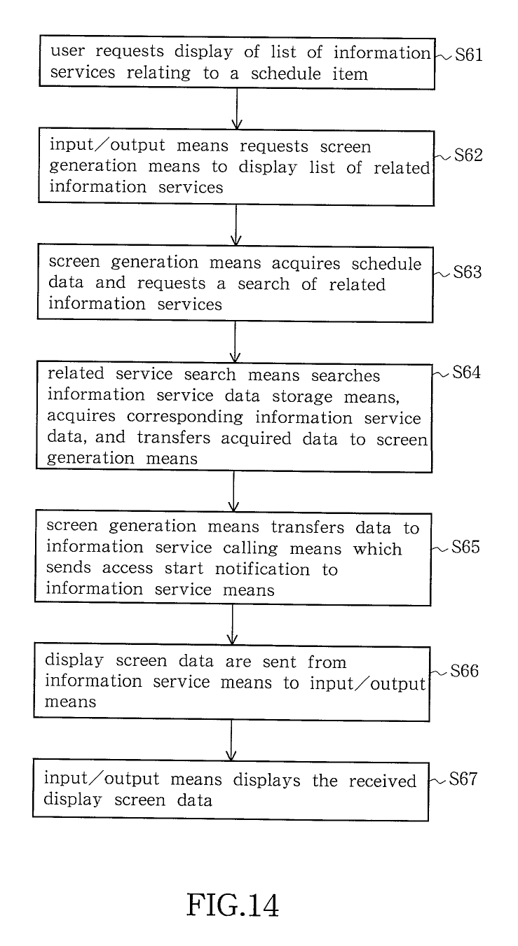

FIG. 14 is a flow diagram showing this operation. First of all, a user requests input/output means 11 to display a list of information services relating to a certain schedule item (S61). As a result of this request, input/output means 11 sends, to screen generation means 12, a request to display a list of related information services, along with the identification number of the specified schedule item (S62). Screen generation means 12 uses the transferred schedule item identification number to acquire, from schedule data storage means 13, the schedule data having that identification number, and sends, to related service search means 14, this data along with a related information service search request (S63). Related service search means 14 generates search keywords from the transferred schedule data and acquires, from information service data storage means 15, data relating to information services that have a keyword matching a search keyword, and transfers the acquired data to screen generation means 12 (S64). Screen generation means 12 looks up the “access method data” contained in the acquired data, connects to information service means 18 via information service calling means 16, and sends an access start notification to information service means 18 (S65). Display screen data are sent to input/output means 11 from the information service means 18 that has received this access notification, and input/output means 11 presents the user with the received display screen data (S66, S67).

At this point, screen generation means 12 acquires the value of the “name” attribute in the acquired information service data and generates code for displaying this character string. At the same time, it looks up the value of the access method data attribute, acquires the information service means URL data stored there, and embeds a link in the display screen. It also incorporates the value of the “summary” attribute in the information service data and generates code for displaying this summary character string. Information service calling means 16 looks up the “access method data” attribute value in the transferred information service data, acquires access procedure information and access address telephone number, etc., sends the acquired data to data transmission means 17 and connects to information service means 18. Display screen data from information service means 18 that has been connected is displayed to the user by input/output means 11. This display screen that has been acquired from information service means 18 is displayed separately from the schedule display screen.

4) A user calls a related information service directly after giving instructions to display a certain schedule item in detail.

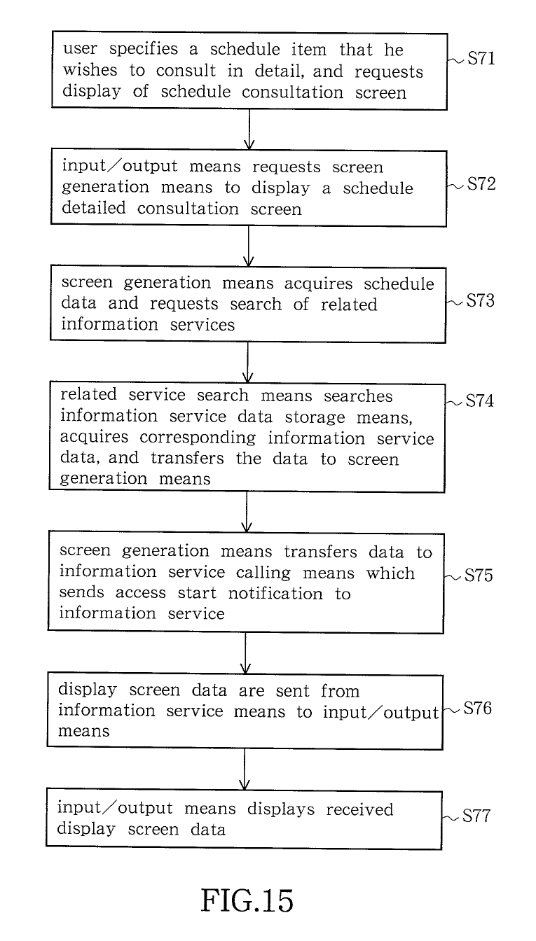

FIG. 15 is a flow diagram showing this operation. First of all, a user specifies, via input to input/output means 11, a schedule item that he wishes to consult in detail, and requests that the schedule consultation screen be displayed (S71). Input/output means 11 sends a schedule detailed consultation screen display request to screen generation means 12, along with the identification number of the specified schedule item (S72). Screen generation means 12 uses the transferred identification number to acquire, from schedule data storage means 13, the schedule data having that identification number, and sends this data to related service search means 14, along with a related information service search request (S73). Related service search means 14 generates search keywords from the transferred schedule data; acquires, from information service data storage means 15, data relating to information services that have a keyword matching a search keyword, and transfers the data to screen generation means 12 (S74). Screen generation means 12 looks up the “access method data” contained in the acquired data and transfers this data to information service calling means 16. Using the schedule data already acquired, screen generation means 12 also generates a schedule consultation screen and sends the screen data to input/output means 11. Information service calling means 16 uses the received “access method data” to connect to information service means 18 via data transmission means 17, and sends an access start notification to information service means 18 (S75). Display screen data are sent from the connected information service means 18 to input/output means 11. Input/output means 11 displays for the user, as separate screens, the display screen data that has been received from screen generation means 12 and from information service means 18 (S76 and S77).

In this operation, if a request is received to display a detailed schedule for an appointment, a list of related information service means 18 of the sort shown, by way of example, on the right-hand side of FIG. 11, is generated. As regards the related information services contained in this list, when a detailed schedule is displayed for consultation, information service calling means 16 accesses information service means 18 for which an access procedure—i.e., begin direct access—has been specified.

5) A user calls a related information service directly after he has caused a schedule consultation screen to be displayed and has specified a period that he wishes to consult, or after he has started to access the schedule management service and has caused a schedule consultation screen to be displayed.

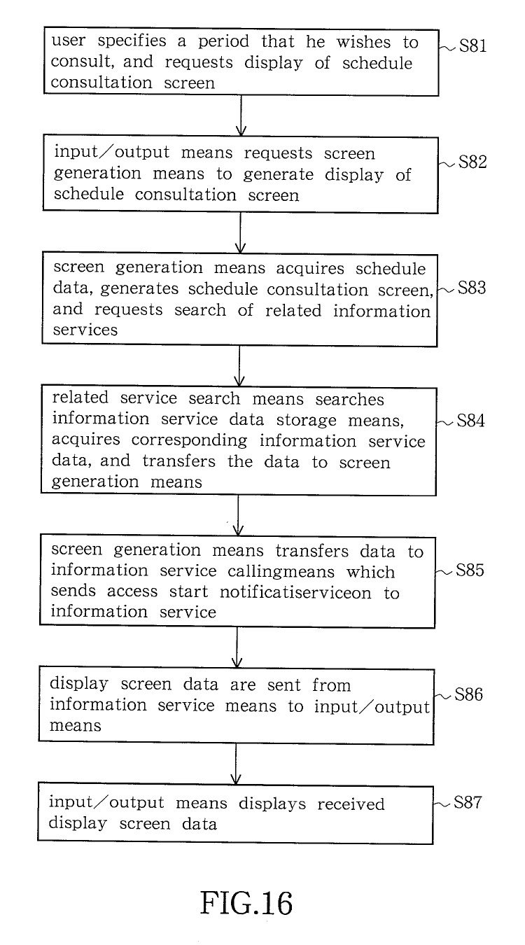

FIG. 16 is a flow diagram showing this operation. First of all, a user specifies, via input to input/output means 11, a period that he wishes to consult, and then requests that the schedule consultation screen be displayed (S81). The same is done when a user starts to access schedule management service 3 via input/output means 11. For example, the situation where a calendar is displayed on the display screen and a particular day on this calendar is specified, can be treated as a request of this type.

Input/output means 11 sends, to screen generation means 12, when a period has been specified, a schedule consultation screen generation request along with the value of the specified period, and when access has already been started to the schedule management service, input/output means 11 sends a schedule consultation screen generation request to screen generation means 12, along with a value for the day and time of the access (S82). When a period has been specified, screen generation means 12 acquires, from schedule data storage means 13, schedule data within the period for which the start day and time has been specified, and generates a schedule consultation screen of the sort depicted in FIG. 6. When access to the schedule management service has started, screen generation means 12 acquires schedule data with a start day and time corresponding to the day on which access started, and generates a schedule consultation screen of the sort shown in FIG. 6. It also sends, to related service search means 14, a request to search related information services, together with the value of the specified day and time and an event giving notification that there has been a schedule consultation screen generation request from input/output means 11 (S83).

Related service search means 14 generates search keywords from the transferred data and acquires, from information service data storage means 15, information service related data having keywords that match the search keywords. The search keywords can be generated from the day and time, or from the event whereby notification was given from input/output means 11. However, there are no particular restrictions on how search keywords are generated. The information service related data acquired are transferred to screen generation means 12 (S84).

Screen generation means 12 looks up the “access method data” within the acquired data, transfers this data to information service calling means 16, uses the previously acquired schedule data to generate a schedule consultation screen, and sends the screen data to input/output means 11. Information service calling means 16 uses the received “access method data” to connect to information service means 18 via data transmission means 17, and sends an access start notification to information service means 18 (S85). Display screen data are sent from information service means 18 to input/output means 11, and input/output means 11 displays for the user, as separate screens, the display screen data received from screen generation means 12 and from information service means 18 (S86 and S87).

In this operation, if for example a calendar has been displayed, when the user clicks on a portion of the calendar corresponding to a date, a command to display a screen listing schedule items arranged for that date is sent to screen generation means 12, along with data corresponding to that date. Screen generation means 12 acquires schedule data with this date related data and, by way of example, displays data of the sort shown in FIG. 6. At this point, related service search means 14 acquires the data for information service means 18 that are related to the schedule data in the schedule item list, and the list is displayed by screen generation means 12. If an access procedure—e.g., start access to a certain related service when the schedule item list is displayed—is specified for an information service means 18 contained in this list, information service calling means 16 sends an access start notification to information service means 18. When access to an information service means 18 in the list display is to begin after a user has instructed such access, information service calling means 16 uses access address information for that information service to send an access start notification, and display screen data for that information service means is sent from information service means 18 to input/output means 11, whereupon a screen for the information service means in question is displayed to the user, and the user receives the service provided by that information service means.

Thus, an information service related to schedule data can be accessed by means of the information service access instruction that a user gives when utilizing the schedule management service, or by means of a schedule consultation instruction. The schedule management service can therefore cooperate with the provision of information services that are relevant to schedules, and a user therefore has the great convenience of being able to utilize an information service without interrupting his use of the schedule management service.

### Second Embodiment

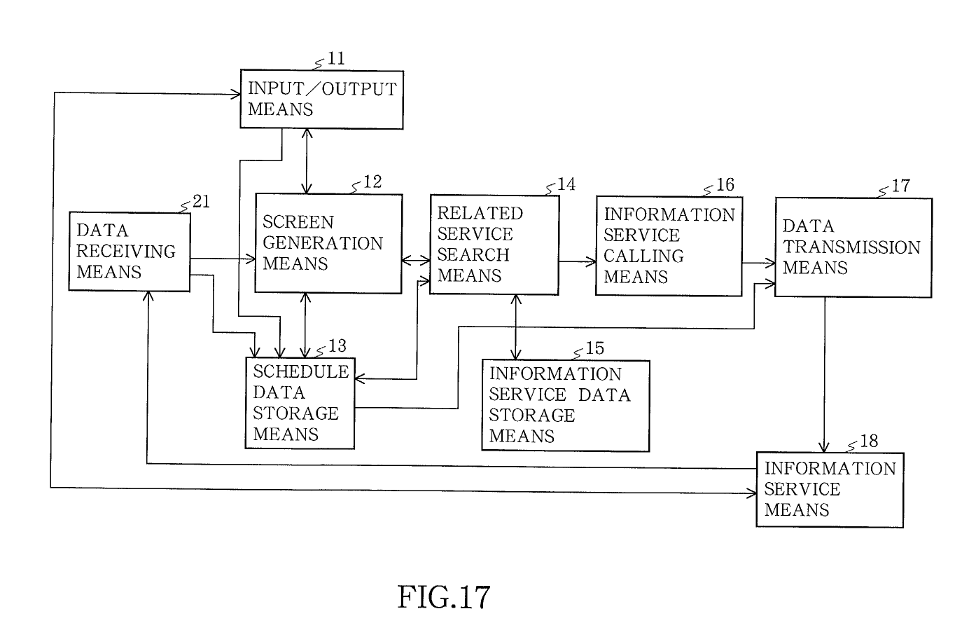

A second embodiment of this invention will now be described. FIG. 17 is a block diagram showing the configuration of this second embodiment.

The configuration of this second embodiment is obtained by adding data receiving means 21 to the configuration of the first embodiment. Data receiving means 21 has the function of receiving data that have been sent from information service means 18 and transferring these data to screen generation means 12 and schedule data storage means 13.

The operations of this second embodiment will be described. The operation of retrieving a list of information services relating to a schedule that the user is consulting and presenting this list to the user, and the operation of accessing an information service relating to a schedule that the user is consulting, are the same as in first embodiment.

In this second embodiment, data receiving means 21 receives various data provided by information service means 18 and transfers this data to screen generation means 12, and hence when screen generation means 12 generates a screen it can access information service means 18, receive data, and display this data after incorporating it in a portion of the screen data. For example, as shown in FIG. 6, it can display newsflash data that has been sent from a newsflash service, and can display advertising data that have been sent from an advertising service. In addition, because screen generation means 12 can receive the results of processing performed on the information service means side in response to user instruction, and can transfer these results to schedule data storage means 13, it can register the received data in schedule data storage means 13 as a single schedule item, and can display it on this basis. Screen generation means 12 can also receive the results of processing performed by an information service means 18 and can update a portion of the screen display presented by the schedule management service. For example, when generating a screen, a recommendation mark of the sort shown in FIG. 9 can be placed against information service means 18 that many users are utilizing. In addition, the schedule management service side can register and display, as a schedule, recommended information that has been sent from an information service means 18.

This second embodiment facilitates close co-operation with information service means 18 and therefore improves the efficiency of various operations for which processing is required in connection with a schedule that has been input by a user. Moreover, data receiving means 21 can include a function for certifying whether or not received data can be trusted. This serves to prevent unauthorized access to schedule management service 3.

### Third Embodiment

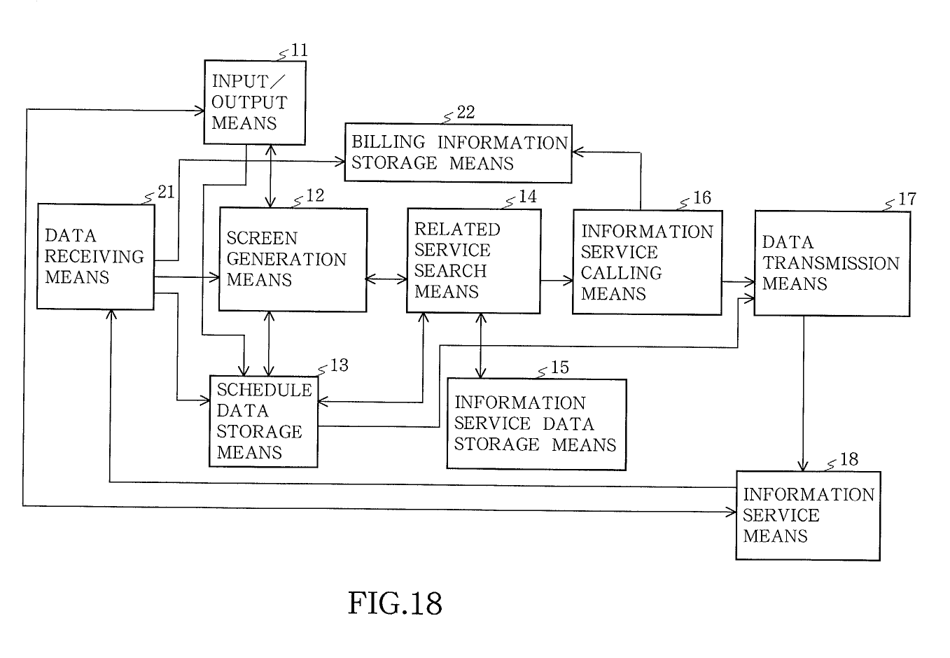

A third embodiment of the invention will now be described. FIG. 18 is a block diagram showing the configuration of this third embodiment.

The configuration of this third embodiment is obtained by adding billing information storage means 22 to the configuration of the second embodiment. This billing information storage means 22 stores customer utilization data sent from information service calling means 16, plus billing information sent from information service means 18.

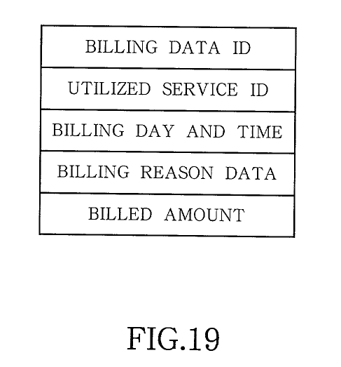

The billing information has the attributes shown in FIG. 19. Namely, it comprises billing data identification number, identification numbers of the services that have been used, billing day and time, data relating to the reason for billing, and billed amount. The “reason for billing” comprises data relating to why charges were generated, and this part of the billing information is for storing items such as the charging category (service charge or product purchase charge), information service utilization time, and the name of a purchased product.

By providing billing information storage means 22, this third embodiment can maintain a record of calls to information services and on this basis can charge users fees for utilizing information services and for advertising. It can also maintain a record of charges for purchase of products from information services, and can bill for these charges on behalf of the information services.

### Fourth Embodiment

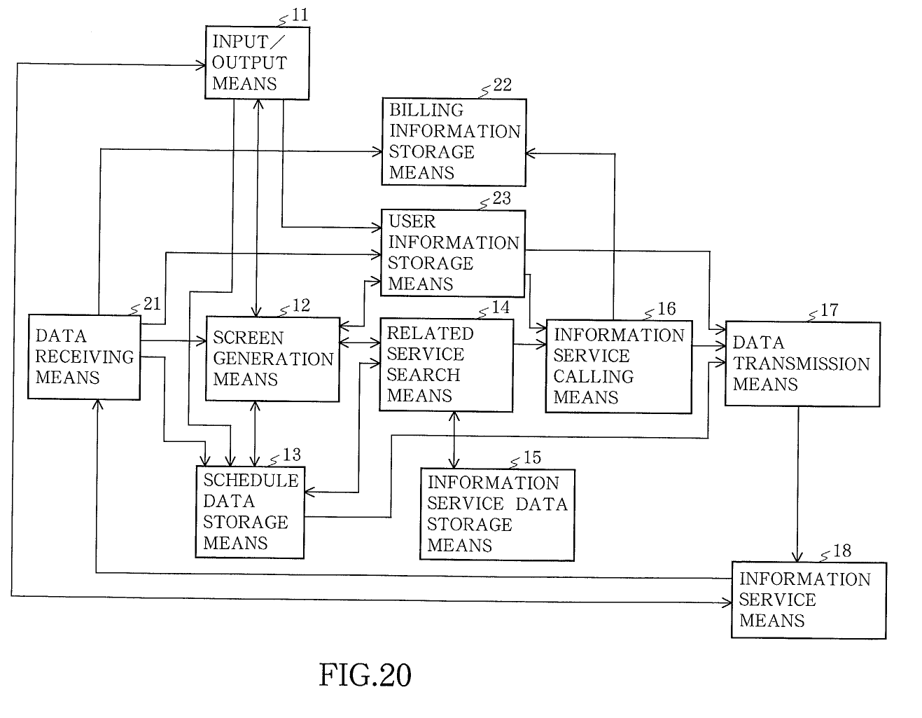

A fourth embodiment of the invention will now be described. FIG. 20 is a block diagram showing the configuration of this fourth embodiment.

The configuration of this fourth embodiment is obtained by adding user information storage means 23 to the configuration of the third embodiment. User information storage means 23 stores user personal information, user information service account information, and user preferences specified in advance by users.

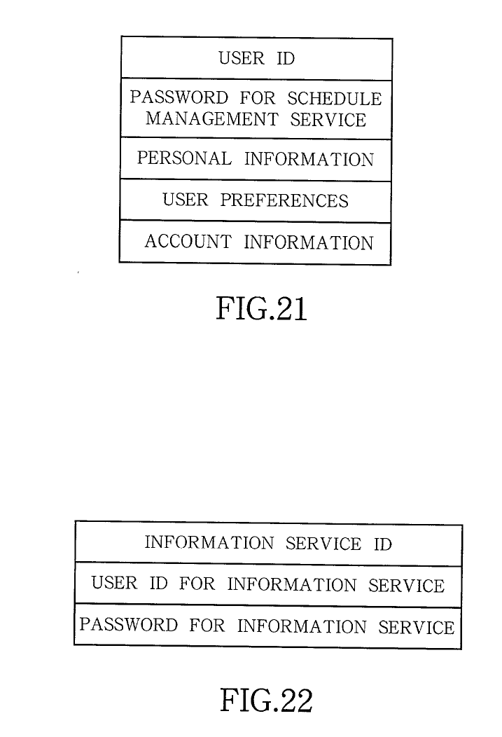

The user information has the attributes shown in FIG. 21, namely: user identification number, password for the schedule management service, personal information, user preferences, and account information. The personal information stored is information relating to an individual user such as e-mail address, name, postal address and date of birth. The user preferences stored include user-specified data such as keywords, areas of interest and information services. As shown in FIG. 22, the account information stored comprises data having the following attributes: information service identification numbers, user identification numbers on those services, and passwords for those services. These are stored for all the user's information service accounts.

User information storage means 23 performs the following operations:

1) provision of stored user information when related service search means 14 searches information service data storage means 15;

2) provision of stored user information when screen generation means 12 generates data for a schedule consultation screen or a user information setting screen;

3) provision of stored user information when data receiving means 21 stores, as a user schedule item, data received from information service means 18, or when data receiving means 21 responds to a request to send back user information;

4) provision of stored user information when information service calling means 16 attempts to access an information service means 18 that requires user authentication;

5) storing of user information that has been sent when input/output means 11 has requested both user information and data storage;

6) storing of user information that has been sent when account data and a data storage request have been sent from the information service means side via data receiving means 21.

The addition of this user information storage means 23 has the following effects:

a) user personal information and user preferences stored in user information storage means 23 can be utilized and searched when related service search means 14 searches related information services;

b) when screen generation means 12 generates screen data, a screen that displays only information that the user wants can be generated by utilizing the user's personal information and preferences to select what data will be displayed;

c) when data to be registered as schedule data has been sent from information service means 18, the user's personal information and preferences can be utilized to ensure that only data wanted by the user will be registered as a schedule item.

If there is an information service means that requires user authentication, co-operation with this is possible when utilizing the schedule management service.

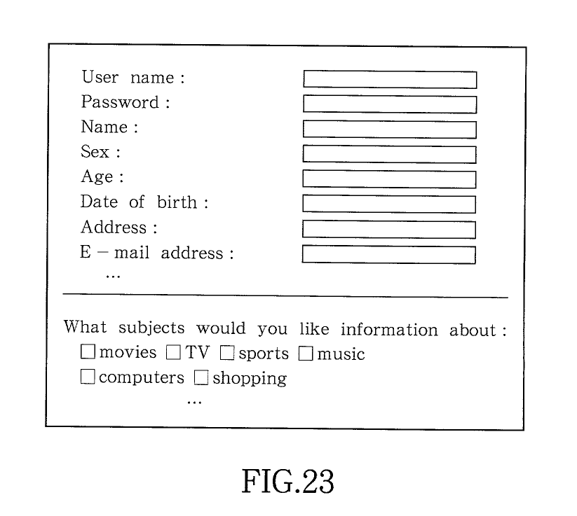

Registration and updating of user information in the user information storage means is performed in the same way as schedule registration, by changing to a user information registration and updating mode, and displaying a screen on the input/output means that enables a user to perform this user information registration and updating. For example, user information is registered by generating and presenting the user with a user information setting screen of the sort shown in FIG. 23.

### Fifth Embodiment

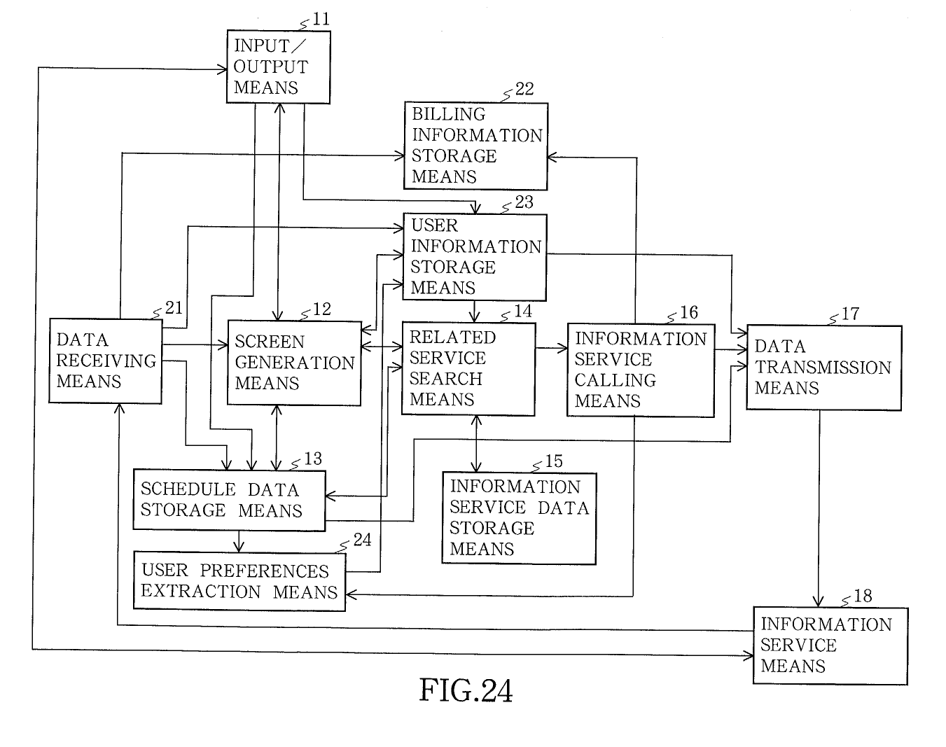

A fifth embodiment of the invention will now be described. FIG. 24 is a block diagram showing the configuration of this fifth embodiment.

The configuration of this fifth embodiment is obtained by adding user preferences extraction means 24 to the configuration of the fourth embodiment. This user preferences extraction means 24 is a means for automatically extracting user preferences by looking at what operations the user has performed, while user information storage means 23 includes means for storing, as user preferences, user preferences that have been extracted by this user preferences extraction means 24.

The operation of this fifth embodiment will now be described. When a user has stored schedule data in schedule data storage means 13, or when a user has issued an instruction, using input/output means 11, to access certain data (i.e., to access an information service) from within related service data that have been presented, user preferences extraction means 24 is called. The stored schedule data and the contents of the accessed information service are accumulated, the user's preferences are extracted from these accumulated data, and the extracted user preferences are stored in user information storage means 23. The extraction of these user preferences can be carried out by first generating a table that gives the correspondence between the schedule data and the preferences. Alternatively, an information search technique can be used, such as employing a thesaurus of the correspondence between preferences and keywords from the schedule data and from the information service.

By utilizing user preferences stored in the user information storage means that was provided in the fourth embodiment, this fifth embodiment has the effect of making it easy to acquire data that the user wants. It also has the effect of being able to provide related information services that always track changes in users' fields of interest. For example, when related service search means 14 searches related information services, it can search by utilizing extracted user preferences. Other advantages of this fifth embodiment are as follows: when generating a screen, user preferences can be utilized to generate a screen that presents only information that the user wants; and when registering schedule data, only data that the user wants is registered as schedule items. A further effect of this embodiment is that these user preferences can be extracted without the user having to perform any input operations.

### Sixth Embodiment

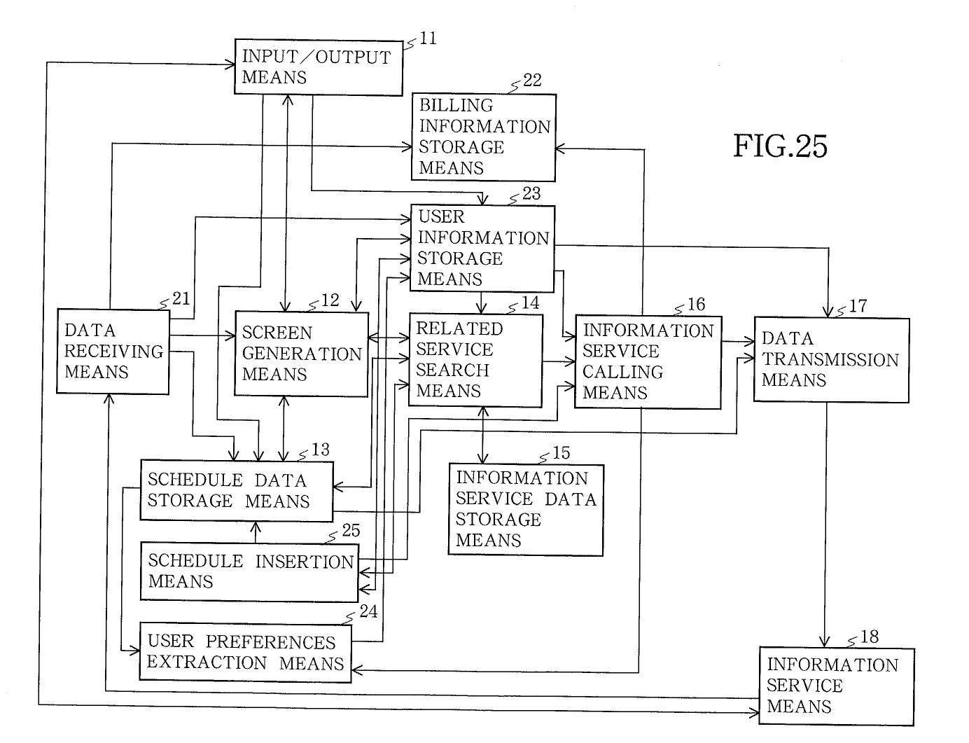

A sixth embodiment of the invention will now be described. FIG. 25 is a block diagram showing the configuration of this sixth embodiment.

The configuration of this sixth embodiment is obtained by adding, to the configuration of the fifth embodiment, schedule insertion means 25 for automatically inserting schedule data. Schedule insertion means 25 is a means for automatically inserting suitable schedule data when there has been a period during which no schedule data have been input or during which there is little schedule data.

The operation of this schedule insertion means 25 will be described. Schedule insertion means 25 accesses schedule data storage means 13 at predetermined intervals, and if it detects a period during which no schedule data have been input or during which there is little schedule data, it acquires user information and user preferences from user information storage means 23. It then sends the acquired data to related service search means 14, which searches related information services that should be accessed. If such an information service means is found as a result of this search, a request to forward data for registration as schedule data is sent to that information service means 18 via information service calling means 16. When data arrives from information service means 18, it is registered in schedule data storage means 13 as schedule data.

This schedule insertion means 25 serves to add a mechanism whereby the user can be presented with data that suggests some new action: for example, the user can be presented with information relating to an event such as a concert or a bargain sale.

### Seventh Embodiment

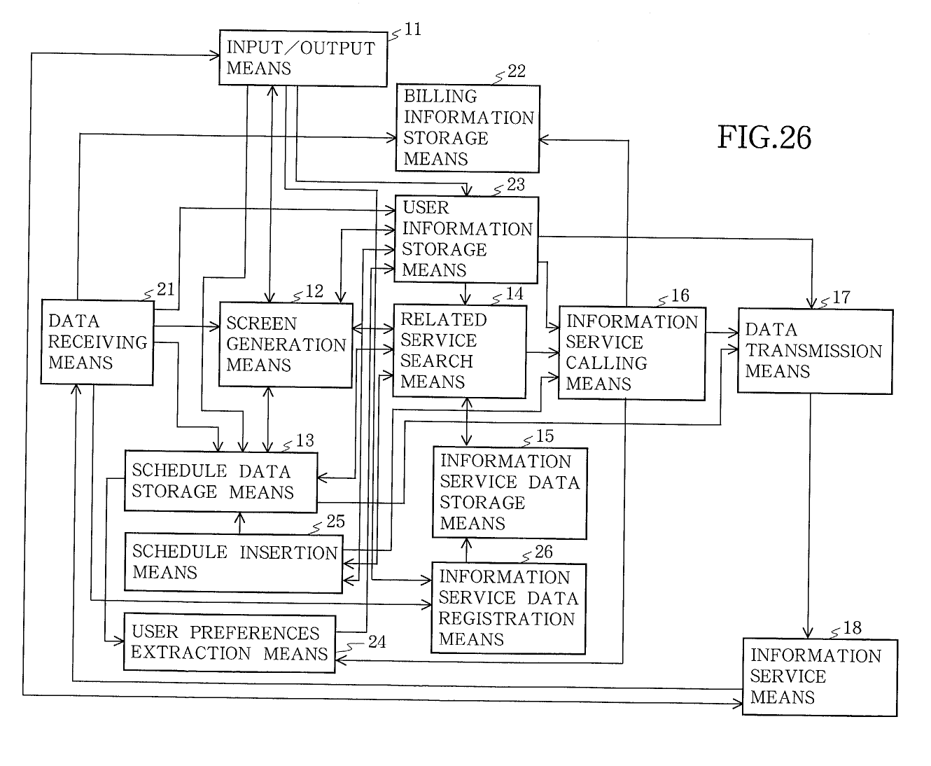

A seventh embodiment of the invention will now be described. FIG. 26 is a block diagram showing the configuration of this seventh embodiment.

The configuration of this seventh embodiment is obtained by adding information service data registration means 26 to the configuration of the sixth embodiment. Information service data registration means 26 has the function of registering, in information service data storage means 15, data pertaining to each information service means.

The operation of this seventh embodiment will be described. Information service data registration means 26 registers, in information service data storage means 15, data pertaining to information service means 18, in the following circumstances:

1) when the schedule management service provider has input data pertaining to an information service means via an input/output means, and has given an instruction for this data to be registered;

2) when a schedule management service user has input data pertaining to an information service means via input/output means 11 and has given an instruction for this data to be registered;

3) when data receiving means 21 has received registration request data that has been sent from an information service means 18;

4) when a user has called an information service means 18 such as a search engine, has searched for information service means, and has utilized an information service found as a result of this search.

Information service data registration means 26 can provide means for registering an information service which the user finds satisfactory. It also serves to customize the presentation of relevant services to users, so that users can be presented with information services that are suited to them.

### Eighth Embodiment

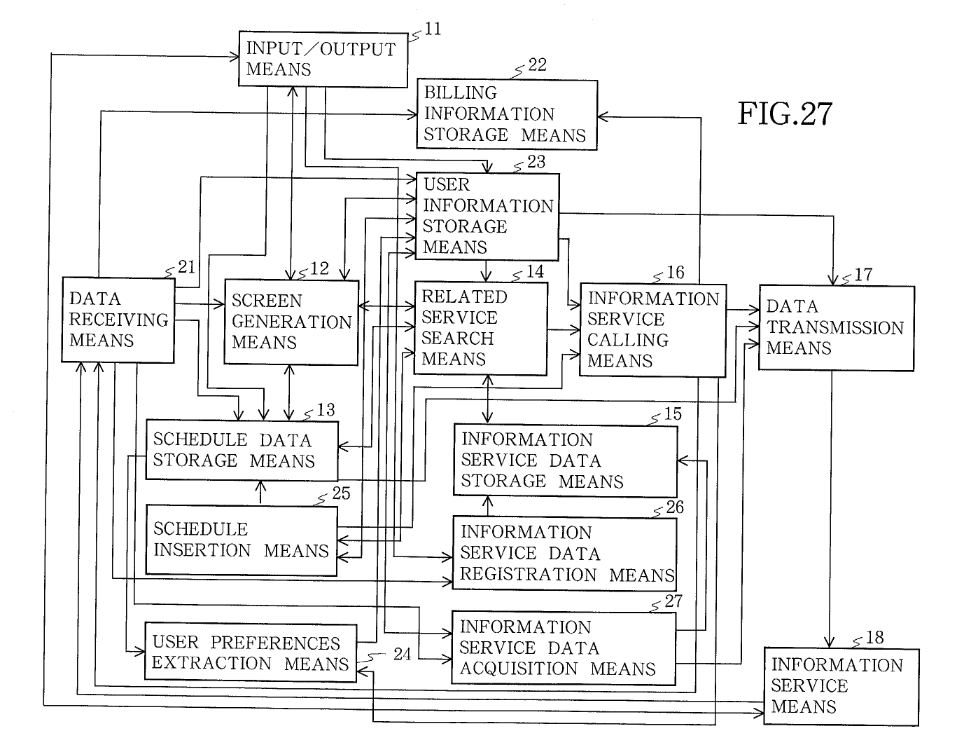

An eighth embodiment of the invention will now be described. FIG. 27 is a block diagram showing the configuration of this eighth embodiment.

The configuration of this eighth embodiment is obtained by adding information service data acquisition means 27 to the configuration of the seventh embodiment. Information service data acquisition means 27 accesses user information storage means 23 and acquires personal information such as the user's address or date of birth, or the user's preferences, searches the network for new information service means that match the acquired information, and registers any discovered information services in information service data storage means 15. This information service data acquisition means 27 enables data relating to new information services to be collected independently of action by an information service supplier or a user.

### Ninth Embodiment

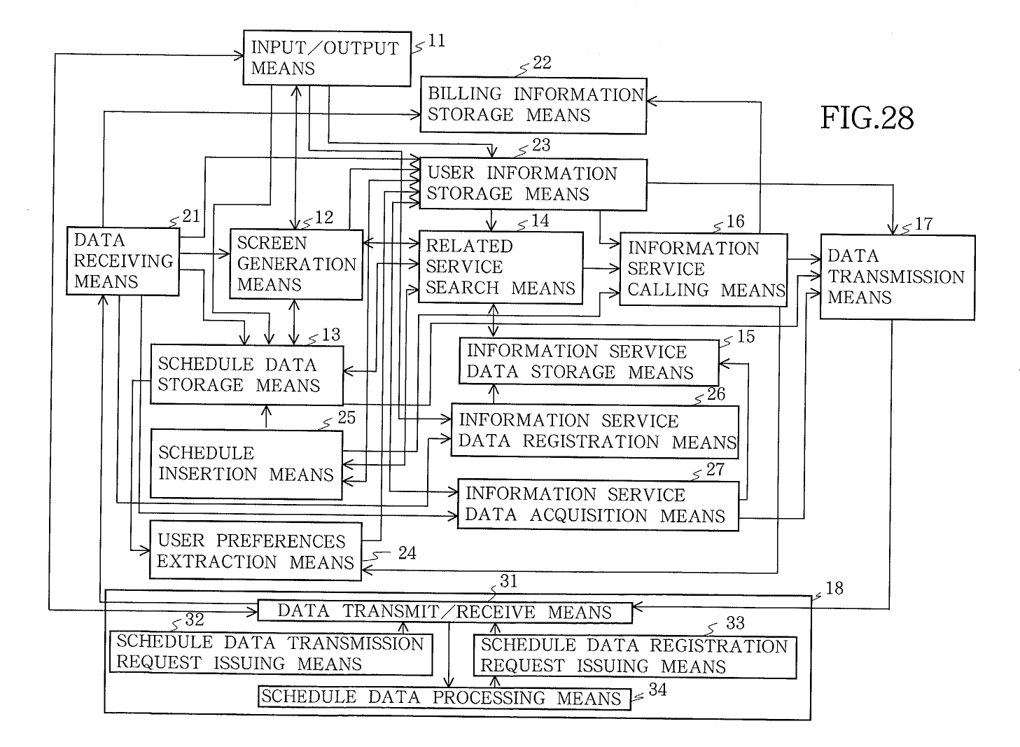

A ninth embodiment of the invention will now be described. FIG. 28 is a block diagram showing the configuration of this ninth embodiment.

This ninth embodiment is obtained by providing the constituent element referenced as “information service means 18” in the first to the eighth embodiments, with a configuration comprising data transmit/receive means 31, schedule data transmission request issuing means 32, schedule data registration request issuing means 33, and schedule data processing means 34.

In this ninth embodiment, data transmit/receive means 31 transmits and receives data to and from the schedule management service and other information services. Schedule data transmission request issuing means 32 checks the free time of a given user, and if it becomes necessary to register schedule data in that free time, issues a schedule data transmission request to the schedule management service. Schedule data registration request issuing means 33 sends, to the schedule management service, a schedule data registration request along with the data whose registration is required. Schedule data processing means 34 receives the schedule data transmission request that has been issued by schedule data transmission request issuing means 32, accepts the schedule data that has been sent from the schedule management service, compares the free time derived from the acquired schedule data with the registration conditions of the schedule data to be registered, and finds the most suitable time.

Because information service means 18 is provided with data transmit/receive means 31, schedule data transmission request issuing means 32, schedule data registration request issuing means 33, and schedule data processing means 34, this ninth embodiment can adjust to users' schedules when autonomously registering schedule items from the information service side. For example, if a schedule information system according to this embodiment is utilized in a delivery scheduling service, the service provider can put together schedules for delivering goods at times thought to be convenient for users, and can notify users of these schedules. This serves to curtail cost increases resulting from recipients being unavailable at the time of delivery, and enables users to receive goods promptly at convenient times.

### Tenth Embodiment

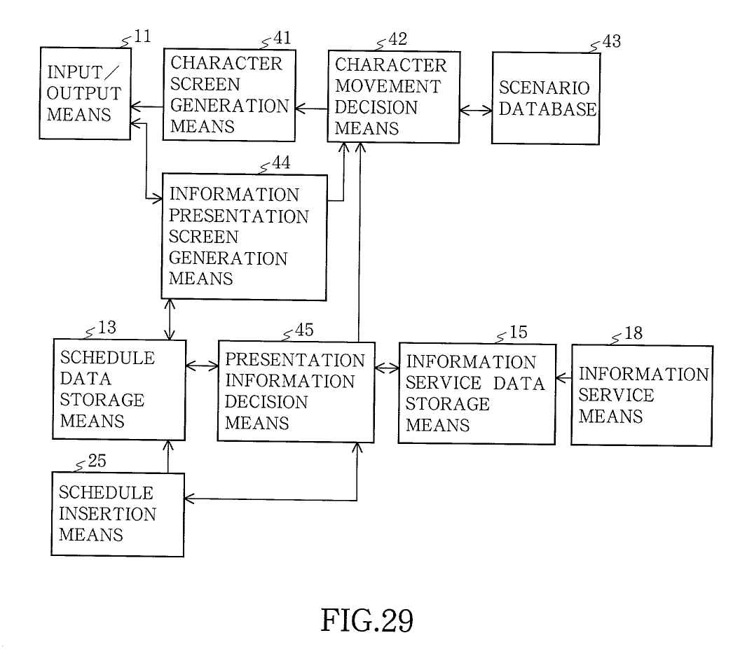

A tenth embodiment of the invention will now be described. FIG. 29 is a block diagram showing the configuration of this tenth embodiment.

This tenth embodiment is configured so that the schedule management service uses an animated character to present information to users. This embodiment corresponds to the sixth embodiment, which, as described above, is provided with schedule insertion means for inserting suggested schedule data in the schedule data storage means that stores the schedule data of users. This tenth embodiment employs, instead of screen generation means 12, an arrangement that has the function of generating, and presenting users with, screens that employ an animated character. In other words, character screen generation means 41, character movement decision means 42, scenario database 43 and information presentation screen generation means 44 in this embodiment together correspond to screen generation means 12 of the first to the ninth embodiments. In addition, presentation information decision means 45 has only some of the functions possessed by related service search means 14: namely, only those functions that relate to the operation of this embodiment.

Character screen generation means 41 draws computer graphics (hereinafter abbreviated to CG) images representing an animated character, and also draws the speech balloons that show what the character is saying. This drawn character screen is displayed to a user by means of input/output means 11. Character movement decision means 42 selects a scenario that determines the movement of the character CG, this selection being based on (i) information service related data that presentation information decision means 45 has retrieved from information service data storage means 15 as data to be presented, and on (ii) the state of the information presentation screen generated by information presentation screen generation means 44. The graphics data and movement scenario for the character CG are stored in scenario database 43, and character movement decision means 42 acquires corresponding scenario data by searching scenario database 43 on the basis of the relevant information service related data and the state of the information presentation screen. In this tenth embodiment, the functions of screen generation means 12 of the first to the ninth embodiments—e.g., functions such as generation of screens for presenting schedule data to users, generation of screens for consultation, and generation of screens for presenting lists of information services—are separate from the operation of character display screen generation, and are implemented by information presentation screen generation means 44.

Because this tenth embodiment uses an animated CG character with a friendly feeling to present a user with information that is pertinent to the state of the user's schedule data, it will be easier to attract the user's interest, and hence increased utilization of the information service provider can be expected, together with improved advertising results.

This tenth embodiment can be modified as follows.

It can be ascertained whether a user's schedule is crowded or has gaps, and appropriate comments can be presented in either case. For example, if nothing is scheduled for a set length of time, the animated character can be made to gently chide the user. In this case, presentation information decision means 45 does not search information service data storage means 15. Instead, it notifies character movement decision means 42 of whether the user's schedule is crowded or has gaps, this information having been obtained by enquiry to schedule data storage means 13, whereupon, in accordance with this information, character movement decision means 42 retrieves movement scenarios and words from scenario database 43 and determines the animated character and remarks to be displayed.

If there are gaps in the schedule, appropriate events relating to Internet utilization can be inserted as user schedule data at free times (week, day, hour), and displays of these suggested events can be accompanied by the animated character. Schedule insertion means 25 can also be used to insert, as user schedule data, items such as suitable bargains found on acquired information services, or events such as films or performances of plays. Although this is the same as the sixth embodiment, the animated CG character can be used in the display of such schedules as well. Appropriate advertising related to a user's schedule can also be inserted and presented.

Presentation information decision means 45 extracts, from schedule data storage means 13, schedule data to be presented, and searches information service data storage means 15 using the categories and detailed contents that have been set in this schedule data. It selects a suitable number of events and advertising data that have been found and that correspond to the specified categories, and sends notification of these to character movement decision means 42. Character movement decision means 42 uses the schedule categories and other parameters to make a selection from scenario database 43. It also generates character speech bubbles for the events and advertising data that have been transferred from presentation information decision means 45, these character speech bubbles matching the selected scenarios, and sends notification of this to character screen generation means 41. The character screen generation means generates character screens on the basis of the transferred speech and scenarios, and displays the screens to the user.

This tenth embodiment has been described in terms of an example of presenting animated character screens. However, it goes without saying that the animated character's words can be output as spoken speech. It also goes without saying that in the first to the ninth embodiments as well, information can be presented as voice output matched to the screen display.

A schedule information system according to this invention can be constructed by installing, in an information processing unit, software that implements these functions.

As has been explained in the foregoing, the present invention makes it easier for the user of a schedule management service to collect information relating to his schedule, thereby enabling the user to reduce the amount of time and effort spent on information collection. In terms of schedule management, the invention can increase the utilization of schedule-related information provided by information services. It is therefore able to provide effective utilization of the information resources of information services.

Moreover, because the user of a schedule management service no longer needs to employ troublesome procedures to collect information relating to his schedule, the user can work more efficiently and conveniently. In addition, a schedule information system according to this invention can assist in information collection by users.

What is claimed is:

1. A schedule information system comprising:
schedule data storage means in which users' schedule data are stored;
information service means for providing users with information; and
related service search means that searches information service means that relate to schedule data stored in the schedule data storage means;
wherein the related service search means includes means which, in response to user instructions to search related services or to consult schedule data, acquires information from information service means that relate to schedule data, and outputs this information to the user.

2. A schedule information system according to claim 1, comprising information service data storage means in which information summarizing the information service means is stored; wherein
the aforementioned related service search means includes means that searches the information service data storage means in response to user instructions or control; and is also provided with means for outputting to the user, along with the aforementioned schedule data, information from the information service means that have been searched by the related service search means.

3. A schedule information system according to claim 2, wherein the aforementioned information service data storage means includes means for:
storing information relating to the access address and access procedure for the information service means; and for
connecting to the information service means on the basis of the aforementioned access address and procedure information that have been retrieved by the related service search means.

4. A schedule information system according to claim 3, which includes means for receiving schedule data related information from an information service means to which a connection has been established, and for outputting the received information along with the aforementioned schedule data.

5. A schedule information system according to claim 4, which includes billing information storage means for receiving billing information from a connected information service means and for storing billing information for each user.

6. A schedule information system according to any of claims 2 to 5, which comprises personal information storage means for storing personal information relating to users;
wherein the aforementioned related service search means includes means for using this personal information along with the schedule data to search the information service data storage means.

7. A schedule information system according to claim 6, which includes user preferences extraction means for extracting information inferred—on the basis of schedule data input by a user or information relating to information service means provided by a user—to be of interest to the user, and for using the extracted information as part of the aforementioned personal information.

8. A schedule information system according to claim 6 or 7, which includes means for acquiring information relating to the aforementioned personal information by connecting to an information service means found by the related service search means on the basis of the personal information stored in the personal information storage means, and for storing this acquired information in the aforementioned user schedule data storage means as part of the schedule data of the user in question.

9. A schedule information system according to claim 2, wherein the aforementioned information service data storage means is provided with information service data registration means whereby the user can register information from an information service means.

10. A schedule information system according to claim 6, which is provided with information service data acquisition means for searching, on the basis of the personal information stored in the personal information storage means, information service means that are in conformity with this personal information; and for storing, in the information service data storage means, information from the searched information service means.

11. A schedule information system according to claim 2, which comprises:
means which, when there is information to be registered as schedule data with the schedule data storage means, requests transmission of the schedule data to the schedule data storage means; and
data transmit/receive means for receiving this schedule data, retrieving information congruent with the received schedule data, and transmitting the acquired information.

12. A schedule information system according to claim 1, which comprises:
display means for presenting the user with information acquired from an information service means;
animated character image generation means for generating animated character images for displaying on this display means; and
means for displaying the animated character images along with the aforementioned acquired information.

13. A schedule information system according to claim 12, which comprises means for selecting a display scenario that is appropriate for the schedule data; and means which, in accordance with the movement pattern obtained by this display scenario selection means, displays the aforementioned animated character images and outputs what the character says.

14. A schedule information system according to claim 2, wherein:
client terminals are connected to a server via a network; and
the aforementioned server contains the aforementioned schedule data storage means, related service search means, information service data storage means, and means for outputting to users information acquired from the information service means.

15. A schedule information system according to claim 14, wherein the information service data storage means contains Internet location information as the address information for accessing the information service means.

16. A schedule information system according to claim 2, wherein the schedule information system is a terminal connectable to an information service means via a network; and
this terminal includes the aforementioned schedule data storage means, related service search means, information service data storage means, and means for outputting to a user information acquired from an information service means.

17. A schedule information system according to claim 16, wherein the information service data storage means contains Internet location information as the address information for accessing the information service means.

18. A storage medium in which software has been stored, this software functioning as a schedule information system according to any of claims 1 to 17, when installed in an information processing unit.
